(19) United States
(12) Patent Application Publication
(10) Pub. No.: US 2023/0252404 A1
(43) Pub. Date: Aug. 10, 2023

(54) SYSTEMS AND METHODS FOR OPTIMIZING AND MANAGING TIRE INVENTORY

(71) Applicant: American Tire Distributors, Inc., Huntersville, NC (US)

(72) Inventors: Siddharth Jain, Huntersville, NC (US); Andrew Brooks, Huntersville, NC (US); AJ Pryor, Huntersville, NC (US); Salman Yousaf, Huntersville, NC (US); David Asaf, Huntersville, NC (US); Rob Helgeson, Huntersville, NC (US)

(21) Appl. No.: 17/665,005

(22) Filed: Feb. 4, 2022

Related U.S. Application Data
(60) Provisional application No. 63/306,552, filed on Feb. 4, 2022.

(51) Int. Cl. G06Q 10/08; G06Q 30/02

(52) U.S. Cl. CPC G06Q 10/087; G06Q 30/0205; G06Q 30/0282

(57) ABSTRACT

Disclosed herein are system and methods for inventory management. The methods can comprise of receiving historical retail data relating to a first product, receiving market demand data relating to the first product, analyzing the historical retail data and the market demand data relating to the first product to determine: a projected number of sales of the first product for a specified time period and margin for each sale of the first product, determining a gross margin return on investment for the first product, determining an optimal stocking level for the first product, and outputting, for display, the optimal stocking level of the first product.

### CROSS-REFERENCE TO RELATED APPLICATIONS

This application claims the benefit, under 35 U.S.C. § 119, of U.S. Provisional Patent Application No. 63/306,552, filed 4 Feb. 2022, the entire contents and substance of which is incorporated herein by reference as if fully set forth below.

### TECHNICAL FIELD

Aspects of the present disclosure relate to a systems and methods for optimizing and managing tire inventory, and, more particularly, for systems and methods for optimizing tire inventory based on tire category, optimal price, and manufacturer reward programs.

### BACKGROUND

Efficient, profitable, and productive management of a retail tire operation represents an enormously challenging problem. In addition to being a generally expensive and bulky commodity, a great many individual tire SKUs exist in varying sizes, styles, and other mechanical specifications. Amidst dynamic conditions with geo-specific trends driven by local markets, vehicle popularity, culture, etc., dealers must decide which brands to align with and which products to promote. This is further complicated by the presence of a complex ecosystem of incentive programs offered by the larger manufacturers, resulting in a dealer's ultimate bottom-line being impacted by a cascade of decision points and thresholds.

Salesclerks also have difficulty using existing inventory systems. Because the average consumer has very little knowledge of varying types of tires, they typically rely on a combination of advice from a salesclerk and the price point they are comfortable with paying. Because a salesclerk is unlikely to gather all relevant information about a driver and because there are multiple suitable options available at a given price point, a consumer is unlikely to end up with the best tire for their needs such that the retailer also maximizes profit. Further, should problems ever arise with a consumer's tires, such a model may lead to distrust from consumers as they have to heavily rely on a salesclerk for information related to their purchase. But if the inventory management system could consider the needs of the consumer prior to stocking the inventory, the consumer could be better served by the salesclerk, and the salesclerk could make better recommendations. Furthermore, the disclosed systems can be leveraged to automatically fulfil and manage retailer inventory, as well as set optimal prices for the inventory. In such a manner, the manpower and time required to manage inventory can be greatly reduced.

Embodiments of the present disclosure address this need as well as other needs that will become apparent upon reading the description below in conjunction with the drawings.

### BRIEF SUMMARY

Aspects of the present disclosure relate to a systems and methods for optimizing and recommending tire inventory, and, more particularly, for systems and methods for determining the most appropriate tires for a retailer to stock based on numerous factors. While the technology and related concepts have been described with respect to tires, it will be understood by one of skill in the art that the technology is applicable across industries and product types.

Examples of the present disclosure can provide an inventory management method comprising: receiving, at a computing device associated with a user, historical retail data relating to a first product; receiving, at the computing device associated with the user, market demand data relating to the first product; analyzing, by the computing device and using a stocking algorithm, the historical retail data and the market demand data relating to the first product to determine: a projected number of sales of the first product for a specified time period; and margin for each sale of the first product; determining, by the computing device and based on (i) the projected number of sales of the first product for the specified time period and (ii) the margin for each sale of the first product; a gross margin return on investment for the first product; determining, by the computing device and based on the gross margin return on investment for the first product, an optimal stocking level for the first product; and outputting, for display at the computing device associated with the user, the optimal stocking level of the first product.

Another example of the present disclosure can provide an inventory optimization method comprising: receiving, at a computing device associated with a user, dealer inventory data comprising sales margin data and reward program data relating to a plurality of products; receiving, at the computing device associated with the user, from a manufacturer associated with each of the plurality of products, product reward data and program prerequisite data; analyzing, by a profit algorithm, the sales margin data and the reward program data relating to the plurality of products to determine constraints comprising: a brand from the dealer inventory data; a style from the plurality of products; analyzing, by the profit algorithm, the product reward data and program prerequisite data to determine constraints comprising: a manufacturer reward program; program requirements; optimizing, based on the profit algorithm, a total profit for the plurality of products; and outputting, for display at the computing device associated with the user, a recommended quantity for each product from the plurality of products and one or more recommended reward programs associated with each product from the plurality of products.

Another example of the present disclosure can provide an inventory optimization method comprising: receiving, at an inventory management system associated with a user, a current price and a current cost for a first product of a plurality of products; creating a price range for the first product based on the current price, the price range comprising a predetermined difference between the current price, a high extreme, and a low extreme; calculated, by a demand model, a predicted quantity sold for the first product based on the current price; calculating an elasticity and a cross-elasticity for the first product indicative of a relationship between the predicted quantity sold and the current price; maximizing, based on the elasticity and the cross-elasticity, the demand model for the first product to obtain an optimized price range; determining that the optimized price range and the price range do not overlap; and determining an optimized price for the first product.

These and other aspects of the present disclosure are described in the Detailed Description below and the accompanying figures. Other aspects and features of embodiments of the present disclosure will become apparent to those of ordinary skill in the art upon reviewing the following description of specific, exemplary embodiments of the present invention in concert with the figures. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments of the invention discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE FIGURES

The accompanying drawings, which are incorporated in and constitute a part of this specification, illustrate multiple embodiments of the presently disclosed subject matter and serve to explain the principles of the presently disclosed subject matter. The drawings are not intended to limit the scope of the presently disclosed subject matter in any manner.

FIG. 1 is a diagram of an exemplary system for inventory management in accordance with the present disclosure

FIG. 2 is a component diagram of an exemplary inventory management system in accordance with the present disclosure.

FIG. 3 is a component diagram of an exemplary user device in accordance with the present disclosure.

FIG. 4 is a flowchart of a method for inventory management in accordance with the present disclosure.

FIG. 5 is a timing diagram of a system for inventory management in accordance with the present disclosure.

FIG. 6 is a flowchart of a method for inventory optimization in accordance with the present disclosure.

FIG. 7 is a timing diagram of a system for inventory optimization in accordance with the present disclosure.

FIG. 8 is a flowchart of a method for inventory optimization in accordance with the present disclosure.

FIG. 9 is a timing diagram of a system for inventory optimization in accordance with the present disclosure.

### DETAILED DESCRIPTION

Aspects of the present disclosure relate to systems and methods for allowing consumers to be more involved in the tire purchasing process. The disclosed systems and methods allow consumers to be better informed while also allowing them to provide more relevant information to merchants so that merchants can provide appropriate product recommendations. While the technology and related concepts have been described with respect to tires, it will be understood by one of skill in the art that the technology is applicable across industries and product types.

The present disclosure can be understood more readily by reference to the following detailed description of exemplary embodiments and the examples included herein. Before the exemplary embodiments of the devices and methods according to the present disclosure are disclosed and described, it is to be understood that embodiments are not limited to those described within this disclosure. Numerous modifications and variations therein will be apparent to those skilled in the art and remain within the scope of the disclosure. It is also to be understood that the terminology used herein is for the purpose of describing specific embodiments only and is not intended to be limiting. Some embodiments of the disclosed technology will be described more fully hereinafter with reference to the accompanying drawings. This disclosed technology may, however, be embodied in many different forms and should not be construed as limited to the embodiments set forth therein.

In the following description, numerous specific details are set forth. But it is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Unless otherwise noted, the terms used herein are to be understood according to conventional usage by those of ordinary skill in the relevant art. In addition to any definitions of terms provided below, it is to be understood that as used in the specification and in the claims, “a” or “an” can mean one or more, depending upon the context in which it is used. Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to and are not intended to imply that the objects so described must be in a given sequence, either temporally, spatially, in ranking, or in any other manner.

Also, in describing the exemplary embodiments, terminology will be resorted to for the sake of clarity. It is intended that each term contemplates its broadest meaning as understood by those skilled in the art and includes all technical equivalents that operate in a similar manner to accomplish a similar purpose.

To facilitate an understanding of the principles and features of the embodiments of the present disclosure, exemplary embodiments are explained hereinafter with reference to their implementation in an illustrative embodiment. Such illustrative embodiments are not, however, intended to be limiting.

The materials described hereinafter as making up the various elements of the embodiments of the present disclosure are intended to be illustrative and not restrictive. Many suitable materials that would perform the same or a similar function as the materials described herein are intended to be embraced within the scope of the example embodiments. Such other materials not described herein can include, but are not limited to, materials that are developed after the time of the development of the disclosed technology, for example.

Disclosed herein are system and methods for inventory management. The methods can include receipt of historical retail data relating to a first product, receiving market demand data relating to that first product, analyzing the historical retail data and the market demand data relating to the first product to determine a projected number of sales of the first product for a specified time period and margin for each sale of the first product, determining a gross margin return on investment for the first product, determining an optimal stocking level for the first product, outputting, for display, the optimal stocking level of the first product, and autogenerating an order to fill the optimum stocking level.

Throughout this disclosure, certain embodiments are described in exemplary fashion in relation to profiling users and making recommendations for tires to purchase. But embodiments of the disclosed technology are not so limited. In some embodiments, the disclosed technique may be effective in profiling users and making recommendations for other types of purchases as well.

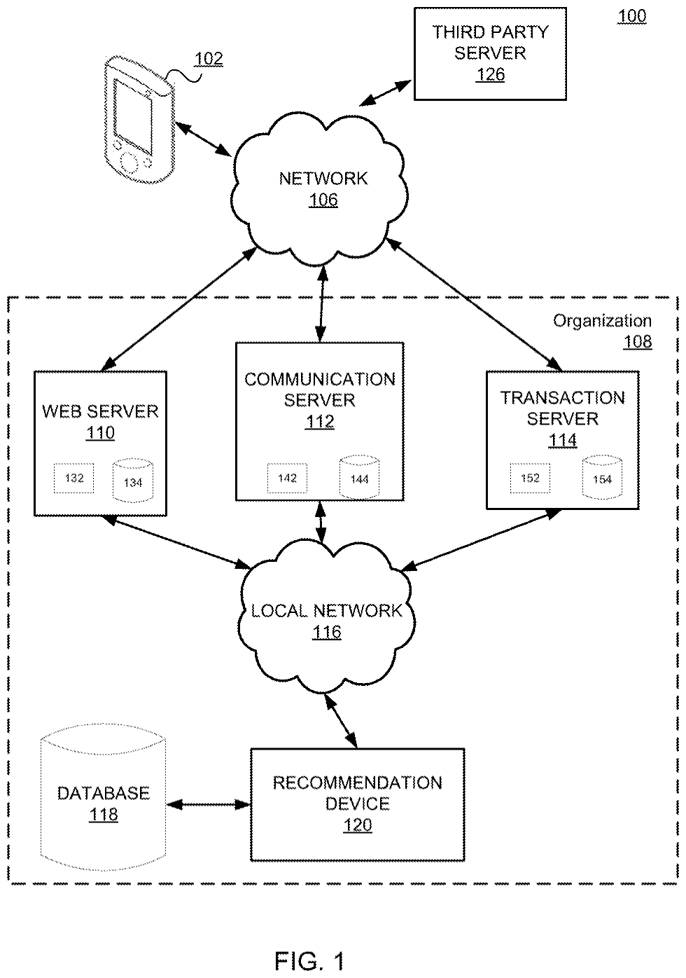

Referring now to the drawings, FIG. 1 is a diagram of an exemplary system 100 that may be configured to perform one or more processes that can provide for inventory management and recommending and/or automatically generating orders for stocking tires for purchase. The components and arrangements shown in FIG. 1 are not intended to limit the disclosed embodiments as the components used to implement the disclosed processes and features may vary. As shown, system 100 may include a user device 102, a third-party server 126, a network 106, and an organization 108 that may include and make use of, for example, a web server 110, a communication server 112, a transaction server 114, a local network 116, an inventory management system 120, and a database 118.

In some embodiments, a user can operate the user device 102. User device 102 can include one of a mobile device, smart phone, general-purpose computer, tablet computer, laptop computer, telephone, PSTN landline, smart wearable device, voice command device, other mobile computing device, or any other device capable of communicating with network 106 and ultimately communicating with one or more components of organization 108 or with third-party server 126. In some embodiments, user device 102 may include or incorporate electronic communication devices for hearing or vision impaired users. User device 102 may belong to or be provide by a customer, or may be borrowed, rented, or shared. According to some embodiments, user device 102 may include a microphone and/or digital camera, a geographic location sensor for determining the location of the device, an input/output device such as a transceiver for sending and receiving data, a display for displaying digital images, one or more processors, and a memory in communication with the one or more processors.

Network 106 may be of any suitable type, including individual connections via the internet such as cellular or WiFi networks. In some embodiments, network 106 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

Network 106 may comprise of any type of computer networking arrangement used to exchange data. For example, network 106 may be the Internet, a private data network, virtual private network using a public network, and/or other suitable connection(s) that enables components in system environment 100 to send and receive information between the components of system 100. Network 106 may also include a public switched telephone network (“PSTN”) and/or a wireless network.

Third-party server 126 may comprise of a computer system associated with an entity other than organization 108 and customers that perform one or more functions associated with the individual and organization 108. For example, in some embodiments, third-party server 126 may comprise of an inventory management server that allows organization 108 to determine availability of tires in a given location. In some embodiments, third-party server 126 may comprise of a weather server that allows organization 108 to determine current and historical weather patterns in a given location.

Organization 108 may include an entity such as a business, corporation, individual, partnership, or any other entity that provides one or more of goods, services, and consultations to individuals such as customers. As shown in FIG. 1, organization 108 may include one or more servers (e.g., 110, 112, and 114) and computer systems (e.g., 120) for performing one or more functions associated with products and/or services that organization 108 provides. Such servers and computer systems may include, for example, web server 110, communication server 112, and/or transaction server 114, as well as any other computer systems necessary to accomplish tasks associated with organization 108 or the needs of customers.

Web server 110 may include a computer system configured to generate and provide one or more websites or mobile applications accessible to customers, as well as any other individuals involved in organization 108's normal operations. Web server 110 may have one or more processors 132 and one or more web server databases 134, which may be any suitable repository of website or mobile application data. Information stored in web server 110 may be accessed (e.g., retrieved, updated, and added to) via local network 116 and/or network 106 by one or more devices (e.g., inventory management system 120 or user device 102) of system 100. In some embodiments, processor 132 may be used to implement a website or mobile application that may provide for profiling users and making tire recommendations based on the profiles.

Communication server 112 may include a computer system configured to receive, process, generate, and transmit electronic communications between a customer operating user device 102, and any other computer systems necessary to accomplish tasks associated with organization 108 or the needs of customers. Communication server 112 may have one or more processors 142 and one or more communication databases 144, which may be any suitable repository of communication data. Information stored in communication server 112 may be accessed (e.g., retrieved, updated, and added to) via local network 116 and/or network 106 by one or more devices (e.g., inventory management system 120) of system 100.

Transaction server 114 may include a computer system configured to process one or more transactions involving an account associated with customers, or a request received from customers. In some embodiments, transactions can include, for example, a product/service purchase, product/service return, financial transfer, financial deposit, financial withdrawal, financial credit, financial debit, dispute request, warranty coverage request, and any other type of transaction associated with the products and/or services that organization 108 provides to individuals such as customers. Transaction server 114 may have one or more processors 152 and one or more transaction server databases 154, which may be any suitable repository of transaction data. Information stored in transaction server 114 may be accessed (e.g., retrieved, updated, and added to) via local network 116 and/or network 106 by one or more devices (e.g., inventory management system 120) of system 100.

In some embodiments, transaction server 114 may track and store event data regarding interactions between user device 102 and organization 108, on behalf of the user of the user device. For example, transaction server 114 may track user interactions such as user survey responses, user purchase requests, user purchases, and any other type of interaction that third-party server 126 may conduct with organization 108 on behalf of a given manufacturer. For instance, the third-party server 126 can communicate with one or more tire manufacturers to obtain manufacturer data such as tire costs, reward program data, and the like.

Local network 116 may comprise of any type of computer networking arrangement used to exchange data in a localized area, such as WiFi, Bluetoot™, Ethernet, and other suitable network connections that enable components of organization 108 to interact with one another and to connect to network 106 for interacting with components in system environment 100. In some embodiments, local network 116 may comprise of an interface for communicating with or linking to network 106. In other embodiments, components of organization 108 may communicate via network 106, without a separate local network 116.

Inventory management system 120 may comprise of one or more computer systems configured to compile data from a plurality of sources (e.g., user device 102, web server 110, communication server 112, and transaction server 114), correlate compiled data, analyze the compiled data, arrange the compiled data, generate derived data based on the compiled data, and storing the compiled and derived in a database such as database 118. According to some embodiments, database 118 may be a database associated with organization 108 that stores a variety of information relating to customers, transactions, and business operations. Database 118 may also serve as a back-up storage device and may contain data and information that is also stored on, for example, databases 134, 144, 154, 260, 270, and 280. Database 118 may be accessed by inventory management system 120 and may be used to store lists of potential tires, information about tires, as well as information about tire purchasers and vehicle information that is associated with past purchasers.

Although the preceding description describes various functions of a web server 110, communication server 112, transaction server 114, authentication device 120, and database 118, in some embodiments, some or all of these functions may be carried out by a single computing device.

According to some embodiments, system 100 may include a software program to implement some or all of the functions of the invention. For example, in some embodiments, user device 102 may store and execute a software program that may interface with and obtain real-time data on the customer status, products, local weather/events (e.g., average weather for customer's location), nearby landmarks, public records relating to the customer or their location, and other such information from other devices (e.g., user device 102, inventory management system 120) to ultimately allow for profiling users and recommending tires for purchase. It will be appreciated by those of skill in the art that although the software is described herein as residing on the user device 102, in various embodiments the software program may reside on any number of other devices, such as for example, the web server 110, communication server 112, transaction server 114, or inventory management system 120.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general-purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all, or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high-level and/or low-level software instructions, such as machine code (e.g., such as that produced by a compiler) and/or high-level code that can be executed by a processor using an interpreter

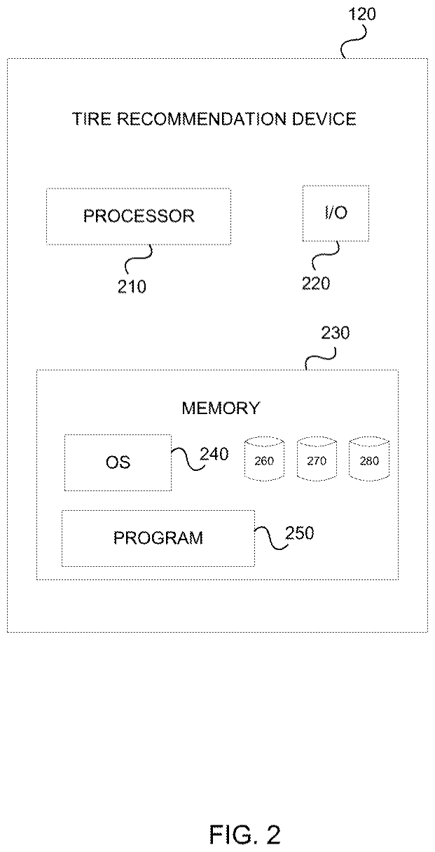

An exemplary embodiment of inventory management system 120 is shown in more detail in FIG. 2. User device 102, web server 110, communication server 112, transaction server 114, and third-party server 126 may have a similar structure and components that are similar to those described with respect to inventory management system 120. As shown, inventory management system 120 may include a processor 210, an input/output (“I/O”) device 220, a memory 230 containing an operating system (“OS”) 240 and a program 250. For example, inventory management system 120 may be a single server or may be configured as a distributed computer system including multiple servers or computers that interoperate to perform one or more of the processes and functionalities associated with the disclosed embodiments. In some embodiments, the inventory management system 120 may further include a peripheral interface, a transceiver, a mobile network interface in communication with the processor 210, a bus configured to facilitate communication between the various components of the inventory management system 120, and a power source configured to power one or more components of the inventory management system 120.

A peripheral interface may include the hardware, firmware and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general-purpose input, and output (GPIO) port, a game port, a universal serial bus (USB), a micro-USB port, a high-definition multimedia (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area network. In some embodiments, a mobile network interface may include hardware, firmware, and/or software that allows the processor(s) 210 to communicate with other devices via wired or wireless networks, whether local or wide area, private or public, as known in the art. A power source may be configured to provide an appropriate alternating current (AC) or direct current (DC) to power components.

Processor 210 may include one or more of a microprocessor, microcontroller, digital signal processor, co-processor or the like or combinations thereof capable of executing stored instructions and operating upon stored data. In some embodiments, processor 210 may be an application or recommendation processor that may execute profiling processes, recommendation processes, or other processes necessary for running an application associated with the organization 108 on the user device 102. Memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein are implemented as a combination of executable instructions and data within the memory 230.

Processor 210 may be one or more known processing devices, such as a microprocessor from the Pentium™ family manufactured by Intel™ or the Turion™ family manufactured by AMD™. Processor 210 may constitute a single core or multiple core processor that executes parallel processes simultaneously. For example, processor 210 may be a single core processor that is configured with virtual processing technologies. In certain embodiments, processor 210 may use logical processors to simultaneously execute and control multiple processes. Processor 210 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

Inventory management system 120 may include one or more storage devices configured to store information used by processor 210 (or other components) to perform certain functions related to the disclosed embodiments. In one example, inventory management system 120 may include memory 230 that includes instructions to enable processor 210 to execute one or more applications, such as server applications, network communication processes, and any other type of application or software known to be available on computer systems. Alternatively, the instructions, application programs, etc. may be stored in external storage or available from a memory over a network. The one or more storage devices may be a volatile or non-volatile, magnetic, semiconductor, tape, optical, removable, non-removable, or other type of storage device or tangible computer-readable medium.

In one embodiment, inventory management system 120 may include memory 230 that includes instructions that, when executed by processor 210, perform one or more processes consistent with the functionalities disclosed herein. Methods, systems, and articles of manufacture consistent with disclosed embodiments are not limited to separate programs or computers configured to perform dedicated tasks. For example, inventory management system 120 may include memory 230 that may include one or more programs 250 to perform one or more functions of the disclosed embodiments. Moreover, processor 210 may execute one or more programs 250 located remotely from system 100. For example, system 100 may access one or more remote programs 250, that, when executed, perform functions related to disclosed embodiments.

Memory 230 may include one or more memory devices that store data and instructions used to perform one or more features of the disclosed embodiments. Memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. Memory 230 may include software components that, when executed by processor 210, perform one or more processes consistent with the disclosed embodiments. In some embodiments, memory 230 may include a customer survey database 260, a tire information database 270, and a recommendation database 280 for storing related data to enable inventory management system 120 to perform one or more of the processes and functionalities associated with the disclosed embodiments.

Tire information database 270 may include stored data relating to vehicles and tires. For example, in some embodiments, tire information database 270 may include information about the user's vehicle including year, make, model, and trim. In some embodiments tire information database 270 may include information about tire fitment (e.g., tire size, load rating, speed rating, etc.), product tier information, product category information etc. Although these databases 260, 270, 280 have been described as being separate databases for the purposes of the present discussion, these databases may alternately be combined into one or more databases.

Inventory management system 120 may also be communicatively connected to one or more memory devices (e.g., databases (not shown)) locally or through a network. Remote memory devices may be configured to store information and may be accessed and/or managed by inventory management system 120. By way of example, such remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

Inventory management system 120 may also include one or more I/O devices 220 that may comprise one or more interfaces for receiving signals or input from devices and providing signals or output to one or more devices that allow data to be received and/or transmitted by inventory management system 120. In exemplary embodiments of the disclosed technology, inventory management system 120 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While inventory management system 120 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the inventory management system 120 may include a greater or lesser number of components than those illustrated.

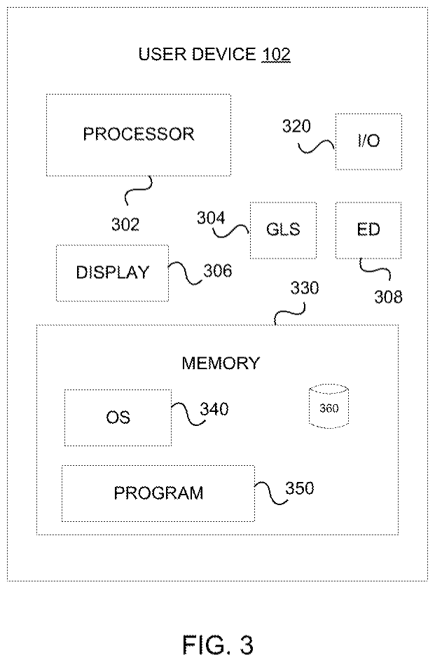

FIG. 3 shows an exemplary interactive embodiment of a user device 102. It is understood that the user device 102 can be in communication with the recommendation device 120. It is also understood that the user device 102 and the recommendation device 120 can be integrated into one singular computing device to perform any of the functionalities described herein by each. As shown, user device 102 may include an I/O device 220, a memory 230 containing an OS 240 and a program 250 and all associated components as described above with respect to authentication device 120. User device 102 may also include a recommendation processor 302 for generating user identity verification data, a geographic location sensor (“GLS”) 304 for determining the geographic location of user device 102, a display 306 for displaying digital images, and an environmental data (“ED”) sensor 308 for detecting sensor data. In some embodiments, an environmental data sensor 308 may include, for example but not limited to, a fingerprint scanner, a microphone, and/or a digital camera. In some embodiments, user device 102 may include one or more processors. According to some embodiments, recommendation processor 302 may include all of the features and functions of processor 210 described above.

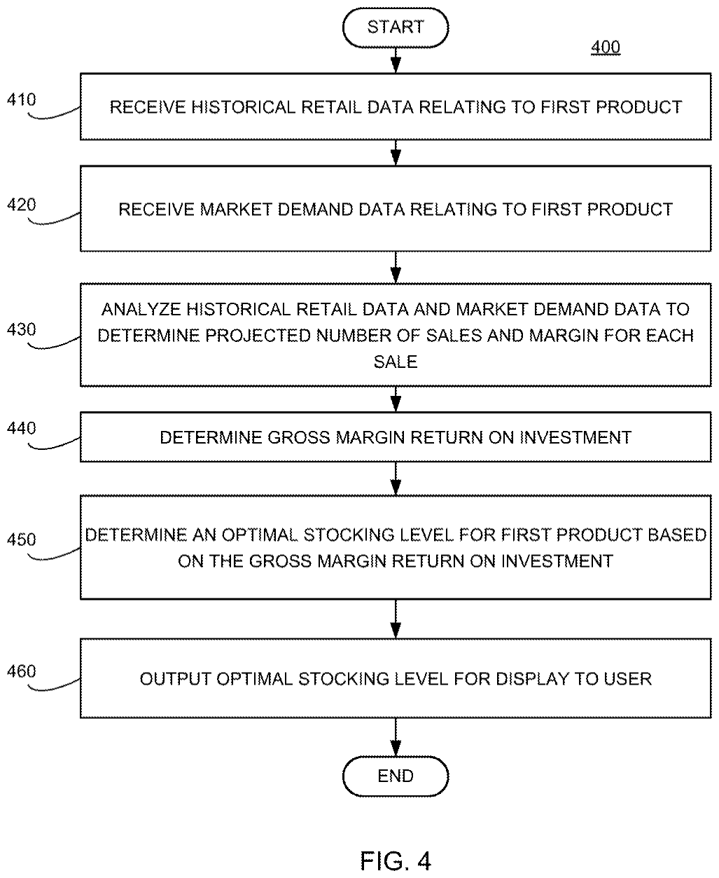

FIG. 4 is a flowchart of an example method 400 for inventory management. Although the method 400 is described as performed by the inventory management system 120, it is to be understood that the method 400, or any of the methods described herein, can be performed by other general-purpose computers, computing devices, and the like.

The inventory management system 120 can receive 410 historical retail data relating to a first product (e.g., a tire). The inventory management system 120 can be associated with a user, such as salesclerk or a tire retailer. For example, the historical retail data can be received from the information database 270. The historical retail data can include historical numbers of tires sold, historical types of tires sold, associated times and dates for sales of tires, and the like. As will be appreciated, if any particular tire sells a larger number than others, that can indicate to the retailer to stock additional tires of that type. For example, the historical retail data can indicate that the retailer sells large numbers of summer sport tires in April and May, while sport tire sales decline sharply in September and October. By way of another example, the historical retail data can include data that can indicate that the tire retailer sells large amounts of sport utility vehicle (SUV) tires, indicating that customers with SUVs frequent the tire retailer. The method 400 can then proceed to block 420.

As further shown, inventory management system 120 can receive 420 market demand data relating to the first product. For example, the market demand data can be received from the information database 270. The market demand data can include, for instance, the historical types of cars in the area around the retailer (e.g., in the same zip code, city, and/or county as the retailer). If there are a disproportionate number of SUVs, for example, that can indicate to the retailer to stock additional suitable tires. The market demand data can be obtained from customer/purchaser transactions or received from a third party, such as a department of motor vehicles. Further, if the market demand data includes vehicle data, the inventory management system 120 can analyze the vehicle data to obtain tire data. For instance, from vehicle data, the inventory management system 120 can determine average tire sizes, tire treadwear, tire compounds, most likely replacement brand, size, or tier of tier and the like. Furthermore, the market demand data for a specific retailer can be normalized versus total market demand data for the area around the retailer. In such a manner, the market demand of any given retailer can be weighted and compared to the average market in which the retailer operates.

The market demand data can include tire sales data across various locations and countries (e.g., the United States and Canada). The market demand data can be stored with granularity down to the level of the zip code. For example, each tire sold can have an associated zip code and tier, where the tier represents the quality. Each tier can represent a different quality of the tire purchase. For example, the market can have more than four different tire tiers: Tier 1, Tier 2, Tier 3, Tier 4, and greater than Tier 4. Tier 1 tires are of the better quality, Tier 4 and higher being the lowest quality.

Additional tire data can be used to determine the market demand data. For example, each tire can be associated with a category, such as Passenger and Light Truck. Furthermore, each tire can have a size code representing the size of that tire. A typical size code value can include a combination of tire width, diameter, and speed rating. The way in which tires sell in these categories, whether from point-of-sale data or tire distribution data can inform market demand for that segment.

Furthermore, data can be obtained from various public and/or private (e.g., licensed or subscription-based) databases. For example, Polk's National Vehicle Population Profile (NVPP) is one such database. As is known to those of ordinary skill in the art, Polk's New Registration Data provides detailed indicators for new vehicle registrations. It also contains the tire size code, make, model and speed rating. This data also has the model year from which we derived age of the vehicle. This data can inform what future market demand is likely to be in each zipcode.

Additionally, rubber manufacturers publish annual data of how many tires were shipped across the US for the companies that have been registered under them. As will be appreciated, such published data can be an indicator for national tire demand. Accordingly, in certain embodiments, the disclosed system and methods can obtain the number of units sold from this data, and the systems and methods can then use such information to perform a zeroth order estimation market demand.

The inventory management system 120 can utilize market demand data for a particular period of time (e.g., from the past 12 months of sales) to calculate projected sales for each product sold by a retailer. The weighted score of each product can be compared, and products with a higher market weight can be prioritized.

The inventory management system 120 can analyze 430 the historical retail data and the market demand data relating to the first product. The inventory management system 120 can employ a stocking algorithm, which uses the projected number of sales of the first product for a specified time period, and margin for each sale of the first product, to come up with a recommended stocking level. For example, by analyzing the product sales from the past 12 months and utilizing the retailer weighted score versus the total market data, the stocking algorithm can determine the products that would be best suited to stock based on projected number of sales. The stocking algorithm can be tuned as desired. For instance, more weight can be placed on the sales data for the total market rather than the specific sales made by the retailer. This can assume that sales by the retailer are driven by or reflected by the market demand instead of vice-versa.

As further shown, the inventory management system 120 can determine 440 gross margin return on investment (GMROI) for the first product. The GMROI can be determined based on the projected number of sales, the margin for each sale, and the cost of the product. The cost of a product can be determined from the retailer sales data. The margin can be calculated from retailer data, along with manufacturer cost data, relating to sales of the product. For example, TireCo Tire margin can be determined from the cost of purchasing the tire from TireCo versus how much the tire sells for at the retailer. Furthermore, the GMROI score for the retailer can be calculated based on the average GMROI score for all products stocked in the retailer's store.

The inventory management system 120 can further determine 450 an optimal stocking level for the first product based on the GMROI, as is shown in FIG. 4. For instance, if the GMROI is high, the inventory management system 120 can determine that the stocking level of the first product should be increased in order to sell more units of the first product which provides the best return on investment (as determined by GMROI). In such a manner, the inventory management system 120 can analyze the GMROI for each product in a retailer and alter the recommended stocking level for each product based on the GMROI. The method 400 can then proceed on to block 460.

In block 460, the inventory management system 120 can output the optimal stocking level of the first product for display to the user. In general, the inventory management system 120 can analyze the dealer's financial performance metrics and make a recommendation for what products the dealer should store based upon how much the dealer is willing to spend and how much space they have. Subsequently, the inventory management system 120 can trigger orders for new products to stock and returns for existing ones that should be cycled out. For example, the inventory management system 120 can use the display 306 on the user device 102 to create a visual depiction of inventory stock for the user. The display 306 can include green arrows along with the number by which the stocking level of the first product should be increased. In addition, the inventory management system 120 can analyze the GMROI for each product in a retailer's inventory and alter the recommended stocking level for each product based on the GMROI, as described above. In response, the inventory management system 120 can automatically generate an order to alter the retailer's inventory such that it will be reflective of the recommended stocking levels. For example, the inventory management system can automatically place orders for additional inventory if the GMROI indicates that the retailer should stock more of that given item. The method 400 can terminate after block 460. However, the method can, alternatively or additionally, proceed on to other method blocks not shown.

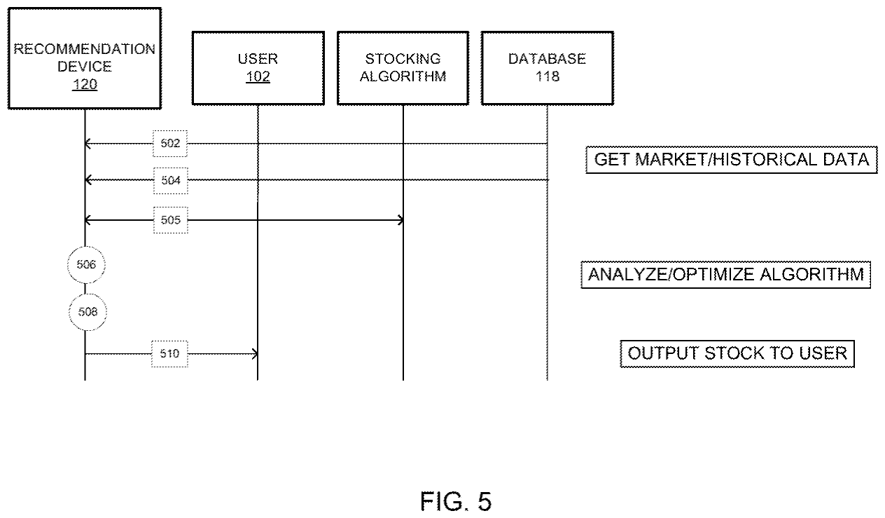

FIG. 5 shows a timing diagram 500 for inventory management. As shown, the inventory management system 120 can receive 502 historical retail data relating to a first product from a database 118. The inventory management system 120 can be associated with a user, such as a salesclerk or a tire retailer. The first product could be a tire. The historical retail data can include, for instance, the historical numbers of tires sold by the tire retailer. If any particular tire sells at a larger quantity than others, that can indicate to the retailer to stock additional tires of that type. The database 118 can be managed by a tire retailer and include vehicle information, tire size data, tire tread data, and tire category data. The first product, and each product sold by the retailer, can be categorized.

The inventory management system 120 can further receive 504 market demand data relating to the first product from the database 118. The first product could be a tire. The market demand data can be calculated from vehicle registration data along with distributor sales data. If there are a disproportionate number of older SUVs, for example, that can indicate to the retailer to stock additional suitable tires. The market demand data can be obtained from customer/purchaser transactions or received from a third party, such as a department of motor vehicles. As described above, in addition to raw data, the market demand data can be determined by a statistical imputation of the raw data. Further, if the market demand data includes vehicle data, the inventory management system 120 can analyze the vehicle data to obtain tire data. For instance, from vehicle data, the inventory management system 120 can use the vehicles tire information (tire size, tire type) along with the market demand for that type of tire size and tire type, along with registered vehicles to come up with an expected number of sales. Furthermore, the market demand data for a specific retailer can be normalized versus total market demand data for the area around the retailer. In such a manner, the market demand of any given retailer can be weighted and compared to the average market in which the retailer operates, depending on what the retailer judges as best reflective of true demand.

The inventory management system 120 can use market demand data to calculate projected sales for each product sold by a retailer. For each product group, the weighted score of each product can be compared, and products with a higher market weight can be prioritized.

The inventory management system 120 can further employ 505 a stocking algorithm to analyze the historical retail data and the market demand algorithm relating to the first product. The stocking algorithm can determine a projected number of sales of the first product for a specified time period and a margin for each sale of the first product. For example, by analyzing the product sales from the past 12 months and utilizing the retailer weighted score versus the total market data, the stocking algorithm can determine a projected number of sales. The stocking algorithm can be tuned as desired. For instance, more weight can be placed on the sales data for the total market rather than the specific sales made by the retailer. This can assume that sales by the retailer are driven by the market demand instead of vice-versa.

Subsequently, the inventory management system 120 can determine 506 a gross margin return on investment (GMROI) for the first product. The GMROI score for a product can depend on the estimated profit for the product based on the projected sales and the margin, where the margin is calculated as the difference between the retail sales price and the cost of the product. For example, TireCo Tire margin can be determined from the cost of purchasing the tire from TireCo versus how much the tire sells for at the retailer. Furthermore, the GMROI score for the retailer can be calculated based on the average GMROI score for all products stocked in the retailer's store.

Further, the inventory management system 120 can determine 508 an optimal stocking level for the first product. The optimal stocking level based on the GMROI and capacity of the retailer. For instance, if the GMROI is high, the inventory management system 120 can determine that the stocking level of the first product should be increased. In such a manner, the inventory management system 120 can analyze the GMROI for each product in a retailer and alter the recommended stocking level for each product based on the GMROI. Furthermore, the capacity of the retailer can determine the number and quantity of products recommended for stocking.

Finally, the inventory management system 120 can output 510 the optimal stocking level of the first product for display to the user. The data is displayed in tabular format containing one record for each SKU that is either currently in stock or being recommended for stocking. This table also includes a recommended action to either Add, Remove, Update, or Maintain the product. “Add” indicates to introduce a previously unstocked SKU, “Remove” indicates to cease stocking a previously stocked SKU, “Update” indicates to continue stocking an existing SKU but at a different quantity, and “Maintain” indicates no change is necessary and the optimal stocking level is already achieved.

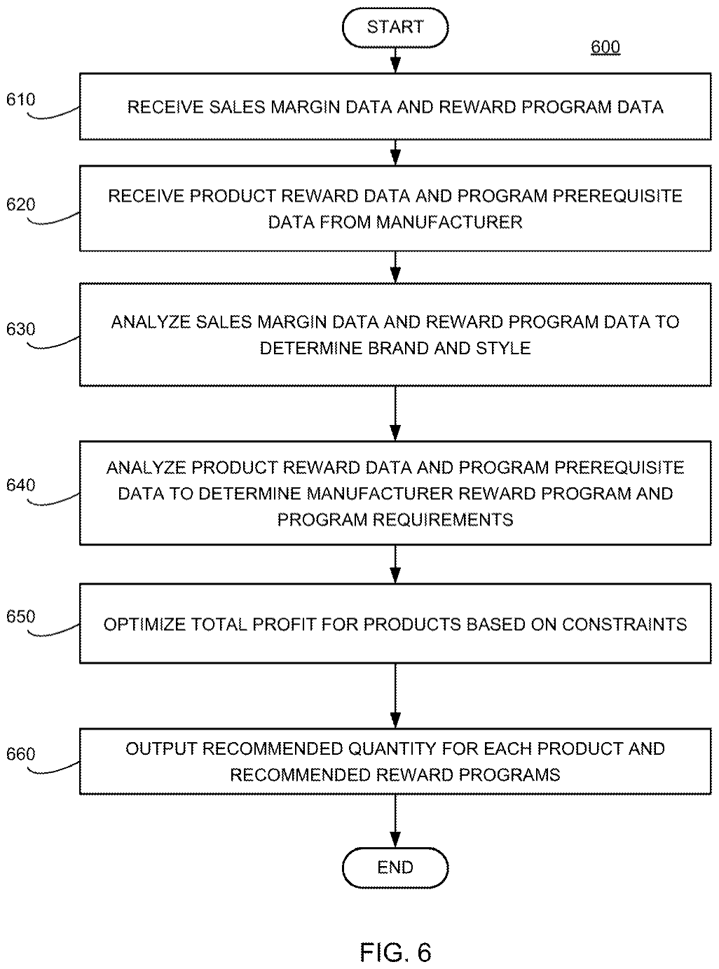

FIG. 6 illustrates a method 600 of inventory optimization. Although the method 600 is described as performed by the inventory management system 120, it is to be understood that the method 600, or any of the methods described herein, can be performed by other general-purpose computers, computing devices, and the like.

In block 610, the inventory management system 120 can receive dealer inventory data. The dealer inventory data can comprise of stocking levels, margin and reward program data relating to a plurality of products. The inventory management system 120 can be associated with a user (e.g., the user device 102), such as salesclerk or a tire retailer. The dealer inventory data can be received from the information database 270. The plurality of products can be a variety of tires sold by a tire retailer, and the plurality of products can each have an associated size, tread, retail price, cost, and the like. For instance, the dealer inventory data can comprise a current inventory of Brand B tires, sales margins for the Brand B tires, and Brand B medallion status. The method 600 can then proceed on to block 620.

In block 620, the inventory management system 120 can receive product reward data and program prerequisite data from a manufacturer associated with each of the plurality of products. For example, the inventory management system 120 can receive the medallion requirements for each level of medallion status and associated reward profits for each level of medallion status for generic tire company TireCo. For example, a dealer who is enrolled in the TireCo Medallion program receives no benefit for 0-999 TireCo tires sold. Upon achieving the threshold of 1000 tires sold, the retailer unlocks a backward-paying reward of $2-5 per tire sold. This can be an example of product reward data. As would be understood by those of ordinary skill in the art, the product reward programs can comprise of programs from a variety of manufacturers and levels that are known. The method 600 can then proceed to block 630.

In block 630, the inventory management system 120 can analyze front-end profit (sales margin) and back-end profit (reward program rewards) relating to the plurality of products. In the present inventory management system 120, the front-end and back-end profit can be inputted into an equation that gives total profit, subject to a variety of constraints. As such, the profit equation can be solved to obtain optimal values of brands and associated products that should be sold to maximize total profit. The inventory management system 120 can determine constraints for optimization. For example, the constraints can include total number of tires do not change, volume moves only between equivalent products, programs the user is willing to consider, and the like. The method 600 can then proceed on to block 640.

In block 640, the inventory management system 120 can analyze the product reward data and the program prerequisite data to determine additional constraints. The constraints can comprise a manufacturer reward program and program requirements. For example, the constraints can include rules specifying which products of the plurality of products are eligible for a given program component (e.g., medallion status). The rules can further specify how many units are required for each reward level and how much profit is paid out for each product on the reward level if the reward prerequisite is met. The rules can also specify whether the units must be purchased from a primary distributor vs. a secondary or tertiary distributor. The method 600 can then proceed on to block 650.

In block 650, the inventory management system 120 can optimize total profit for the plurality of products based on the profit equation comprising front-end and back-end profit, as well as the constraints determined above. The inventory management system 120 can utilize mathematical fragmentation to aid in the optimization. Those of ordinary skill in the art would understand that the optimization can be carried out in a variety of ways. The optimization engine employed by the inventory management system 120 can be a large, disjoint problem, and specifically one that can vary tremendously depending upon user input. The goal can be to construct a single, well-formed linear target function that can then be optimized against linear constraints (described above). Each of the constituent input pieces (e.g., a program selection or indication of wanting to increase a given brand) are formed into “optimization fragments”, each of which is added or modified as a piece of the overall equation. By combining all of the generated pieces of information from the various fragments, the inventory management system 120 arrives at the final problem using integer programming whose solution is the answer for the optimal strategy given the current settings. The method 600 can then proceed on to block 660.

In block 660, the inventory management system 120 can generate an output to display a recommended quantity for the retailer to sell for each product from the plurality of products. The inventory management system 120 can also generate an output of one or more recommended reward programs associated with each product from the plurality of products. The output can indicate what the user's annual sales targets by tire brand and style should be and in which programs to enroll. The method 600 can terminate after block 660. However, the method 600 can also proceed on to other method steps not shown.

For example, the inventory management system 120 can analyze the optimization results for each product in a retailer and alter the recommended quantity to stock for each product based on the optimization problem, as described above. In response, the inventory management system 120 can automatically alter the retailer's inventory while also balancing GMROI-based recommendations as described above. For example, the inventory management system can automatically place orders for additional inventory if the optimization results indicates that the retailer should stock more of that given item. Further the inventory management system 120 can automatically enroll the retailer in one or more reward programs if the optimization results determine that profit can be maximized by joining the reward programs.

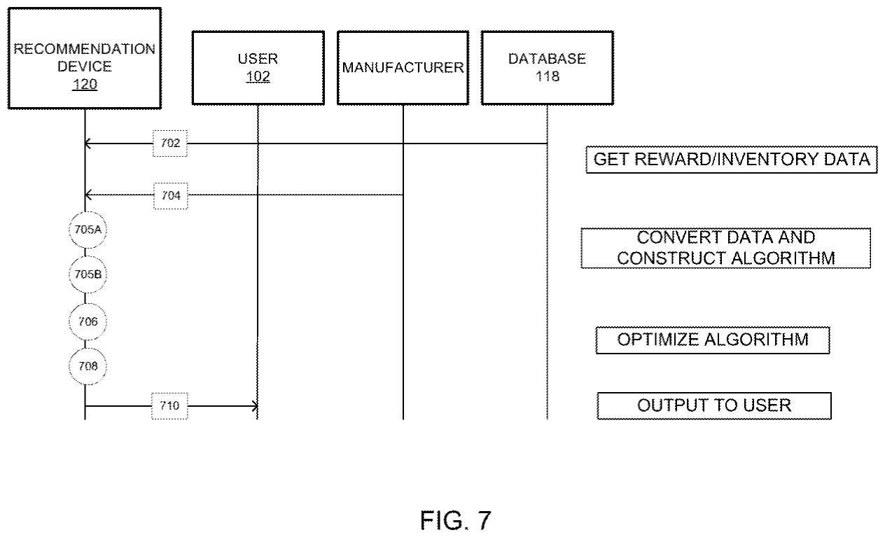

FIG. 7 illustrates a timing diagram 700 for an inventory optimization system. The inventory management system 120 can receive 702 dealer inventory data from a database 118. The dealer inventory data can comprise of stocking position, sales margin and reward program data relating to a plurality of products, as described above in FIG. 6. The inventory management system 120 can be associated with a user (e.g., a user device 102 as described in FIG. 3), such as salesclerk or a tire retailer. The plurality of product can be a variety of tires. For instance, the dealer inventory data can comprise a current inventory of Brand B tires, sales margins for the Brand B tires, and Brand B medallion status.

As in FIG. 6, the inventory management system 120 can receive 704 product reward data and program prerequisite data from a manufacturer associated with each of the plurality of products. The product reward data and program prerequisite data can alternatively be stored in the database 118 or retrieved directly from the manufacturer. For example, the inventory management system 120 can receive the Brand B medallion requirements for each level of medallion status and associated reward profits for each level of Brand B medallion status as was discussed above.

The inventory management system 120 can analyze 705A historical sales, sales margin and the reward program data relating to the plurality of products. The inventory management system 120 can determine constraints for optimization based on program requirements and user inputs. The constraints can be comprised at the brand level or style level. Alternatively, or additionally, the inventory management system 120 can analyze 705B the product reward data and the program prerequisite data to determine additional constraints depending on user input related to what programs they are willing to consider. The constraints can comprise of a manufacturer reward program and program requirements.

The inventory management system 120 can then optimize 706 for total profit for the plurality of existing products the retailer sells, or new products based on the profit algorithm and the constraints. The inventory management system 120 can utilize mathematical fragmentation to aid in the optimization. In other words, the inventory management system 120 can fragment 708 the optimization problem to perform the optimization via integer programming in an easy and efficient manner.

Finally, the inventory management system 120 can output 710 to display a recommended quantity for each product from the plurality of products. The inventory management system 120 can also output one or more recommended reward programs associated with each product from the plurality of products.

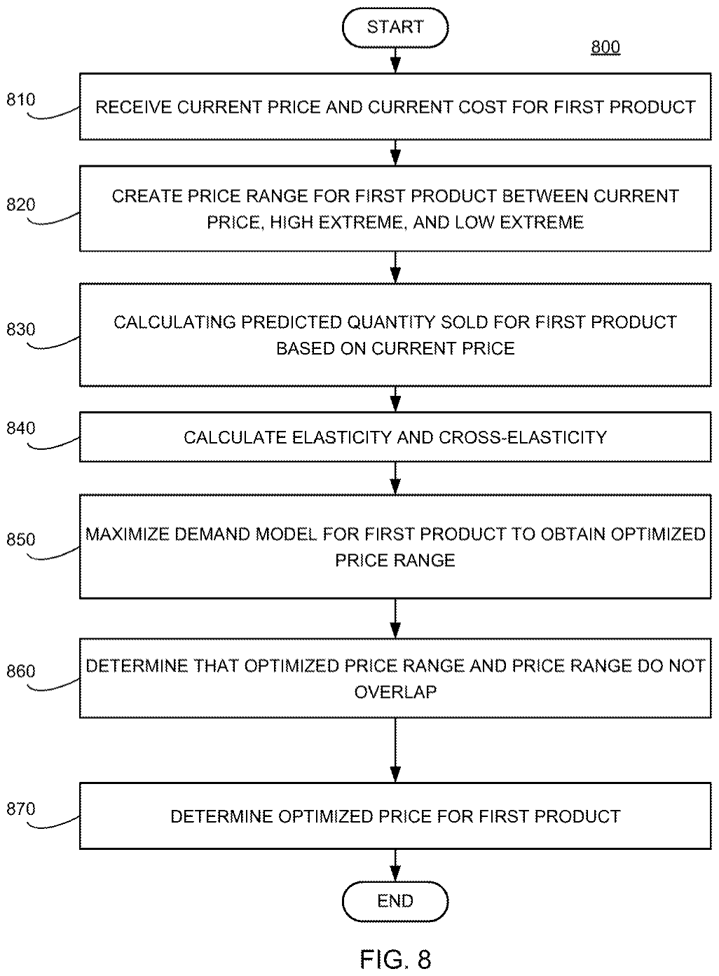

FIG. 8 illustrates a method 800 for optimizing pricing. Although the method 800 is described as performed by the inventory management system 120, it is to be understood that the method 800, or any of the methods described herein, can be performed by other general-purpose computers, computing devices, and the like. An example of a method for optimizing inventory is outlined in U.S. Provisional Patent Application No. 63/306,552, which is herein incorporated by reference as if fully set forth below.

In block 810, the inventory management system 120 can receive a current price and a current cost for a first product of a plurality of products. The inventory management system 120 can be associated with a user (e.g., the user device 102 as described in FIG. 3), such as salesclerk or a tire retailer. The current price and the current cost can be received from the information database 270. The plurality of products can be a variety of tires. For example, the inventory management system 120 can receive from an information database 270 associated with a tire retailer, the current price and current cost for TireCo tires. The method 800 can then proceed on to block 820.

In block 820, the inventory management system 120 can create a price range for the first product based on the current price. The price range can be a high extreme (maximum), a low extreme (minimum) and the current price. The high extreme and the low extreme can be a predetermined difference away from the current price. As a non-limiting example, the current price can be $86 per tire, and the predetermined difference can be $15 on either side of the current price (e.g., $101 and $71, respectively). Furthermore, each product can have multiple buckets: $60 to $71, $71 to $101, and $101 to $10. In such a manner, the inventory management system 120 can create a set of “price buckets”, one of which the current price of the first product falls. This step can be performed for any product of the plurality of products. The method 800 can then proceed on to block 830.

In block 830, the inventory management system 120 can use a demand model to calculate a predicted quantity sold for the first product based on a given price. The predicted quantity sold can be based on a predetermined time interval. For example, the demand model can predict the tire quantity sold for the following day, week, month, or year. The demand model can be a forecasting model to predict the demand for the first product. The method 800 can then proceed on to block 840.

In block 840, the inventory management system 120 can calculate an elasticity and a cross-elasticity for the first product. Each of the elasticity can be indicative of a relationship between the predicted quantity sold and the current price. Further, the cross-elasticity can define a relationship between the predicted quantity sold and the price of the other products in the plurality of products, given a fixed current price. Examples of elasticity and cross-elasticity are set forth in U.S. Provisional Patent Application No. 63/306,552. The method 800 can then proceed on to block 850.

In block 850, the inventory management system 120 can group products based on their tire size, within each tire size, find the price range for each product such that gross profit is maximized. As a non-limiting example, using the price buckets above that consist of buckets $60 to $71, $71 to $101, and $101 to $110, the inventory management system 120 can determine that the optimal price range for product A is $60 to $71 and product B $101 to $110. The maximization can take into account the elasticity and the cross-elasticity. The inventory management system 120 can utilize a mixed integer optimization and/or quadratic programming. In such a manner, the inventory management system 120 can create an optimized “price bucket” for the first product and all products within the same tire size to be priced in. The method 800 can then proceed on to block 860.

In block 870, the inventory management system 120 can then determine an optimized price range for the first product and all products within the same tire size. For example, the inventory management system 120 can determine that the optimized price range is $60 to $71. Therefore, the portfolio of products can be moved between “price buckets” to an optimized set of “price buckets.” The method 800 can terminate after block 870. However, the method 800 can also proceed on to other method steps not shown. For example, the inventory management system 120 can automatically alter the prices of products on a retailer's website to reflect the optimized price. Furthermore, an exact optimal set of prices can be determined by adding an additional step wherein optimization occurs within each of the pricing buckets.

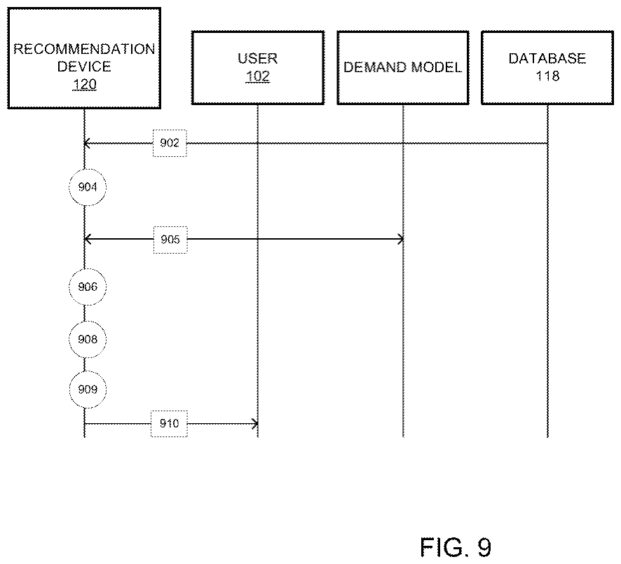

FIG. 9 illustrates a timing diagram 900 for optimizing inventory. The inventory management system 120 can receive 902 a current price and a current cost for a first product or a plurality of products from a database 118. The inventory management system 120 can be associated with a user, such as salesclerk or a tire retailer. The plurality of products can be a variety of tires. For example, the inventory management system 120 can receive, from an information database 270 associated with a tire retailer, the current price and current cost for TireCo tires.

The inventory management system 120 can create 904 a set of price ranges for the first product and set of products within the same tire size based on the current price. The price range can be a high extreme (maximum), a low extreme (minimum) and the current price. The high extreme and the low extreme can be a predetermined difference away from the current price. In such a manner, the inventory management system 120 can create a set of “price buckets”. This step can be performed for group of tire sizes for a plurality of products. Examples of creating a price range are set forth in U.S. Provisional Patent Application No. 63/306,552.

The inventory management system 120 can use 905 a demand model to calculate a predicted quantity sold for the first product based on a given price. The demand model can be a forecasting model to predict the demand for the first product and products within the same tire size for the range of prices within each bucket. The predicted quantity sold can be based on a predetermined time interval. For example, the demand model can predict the tire quantity sold for the following day, week, month, or year. The inventory management system 120 can calculate 906 an elasticity and a cross-elasticity for the first product and all products within the same tire size. Each of the elasticity and the cross-elasticity can be indicative of a relationship between the predicted quantity sold and the price. Further, the cross-elasticity can define a relationship between the predicted quantity sold and the price of the other products in the plurality of products. Examples of elasticity and cross-elasticity are set forth in U.S. Provisional Patent Application No. 63/306,552.

The inventory management system 120 can maximize 908 the demand model to obtain an optimized price range for the first product and for each product in the same tire size group. The maximization can take into account the elasticity and the cross-elasticity. The inventory management system 120 can utilize a mixed integer optimization and/or quadratic programming. In such a manner, the inventory management system 120 can create an optimized “price bucket” for the first product to be priced in such that gross profit is maximized. As a non-limiting example, using the price buckets from above of $60 to $71, $71 to $101, and $101 to $111 the inventory management system 120 can determine that the optimized price range for the first product is actually from $60 to $71, when the second product's optimal range is $71 to $101. Therefore, the first product can be moved between “price buckets” to an optimized “price bucket.”

### Example Use Case

A dealer with one location can utilize the inventory management system 120. The dealer can carry tires for two categories of cars: passenger car and light truck. Tires in the passenger category can have a size of 245/35/18, a speed rating of Y, and be categorized in Tier 1. Tires in the light truck category can have a size of 245/35/18, a speed rating of Y, and be categorized in Tier 1 as well. The two categories can have a total of four products, two of which can be currently carried by the dealer. The inventory management system 120 can first receive data for the passenger category to obtain a total number of market sales of 4000 for that category (e.g., historical sales data for how many tires in the passenger category have been sold based on distributor sales in the zip codes serviced by the retailer). This can be normalized by the total number of tire sales across all tire types for the passenger category, which is 100,000. This can yield a normalized historical sales score of 0.04.

The inventory management system 120 can then receive category market demand data which is imputed and indicating a passenger tire market demand of 500,000 for the passenger category. The market demand data can include demand data for the passenger category as well as demand data for all groups in the dealer's zip code. This can be normalized by the total demand across all tire types for the passenger category, which is 10,000,000. This can yield a normalized market score of 0.05.

The inventory management can repeat the above steps for the light truck category. Distributor sales data of 5000 and a total sales normalization of 11,000 can yield a normalized historical sales score of 0.05. An imputed market demand of 45,000 and a total market normalization of 500,000 can yield a normalized market score of 0.09.

The inventory management system 120 can also weigh the normalized historical sales score and the normalized market score. The weighing can be automatic or based on parameters input by a user. This can indicate how well the sales data aligns with the market and can represent the market behavior. The normalized historical sales score and the market score can further be normalized with respect to the specific categories (e.g., passenger and light truck).

The inventory management system 120 can then receive dealer sales data to measure dealer performance using the 12-month time period corresponding to the market demand data. The dealer sales data can indicate that the dealer sold 80 tires in the passenger category and 120 tires in the light truck category. The inventory management system 120 can then apply the normalized specific category scores to the dealer sales data, yielding category-specific sales of 30 for passenger tires and 74 for light truck tires.

The inventory management system 120 can then calculate projected sales for each product in the categories (e.g., passenger and light truck). Using the 80 tires sold in the passenger category, 30 can be sales of Product 1 and 50 can be from Product 2. Using the category specific sales of 30, the projected sales for Product 1 can be 30 and Product 2 can be 40. Using the 120 tires sold in the light truck category, 100 can be sales of Product 3 and 20 can be sales of Product 4. Again, applying the category-specific score can yield projected sales of 87 for Product 3 and 47 for Product 4. The dealer can also assign a weight to the sales data. If the dealer wants to base the prediction mostly on the dealer's own past performance, the dealer sales data can be assigned a higher weight. Alternatively, if the dealer wants to base the prediction on the market behavior, the dealer sales data can be assigned a lower weight.

The inventory management system 120 can also calculate backend profit based on the brand of product and associated dealer programs. The dealer can simply enter the brand of the products to obtain the backend profit based on manufacturer data (e.g., earnings per tire, reward programs, etc.). Finally, the inventory management system 120 calculates the gross margin return on investment for the products based on the margin, the projected sales, the cost, and the stocking level. For example, Product 1 might have a cost of $100, a retail price of $110, and a backend profit of 2. Product 2 might have a cost of $120, a retail price of $135, and a backend profit of 1. Product 3 might have a cost of $80, a retail price of $100, and a backend profit of 4. Product 4 might have a cost of $100, a retail price of $105, and a backend profit of 2. Therefore, the calculated GMROI for Products 1-4 can be 98%, 142%, 681%, and 94%, respectively.

By altering the stocking level to maximize the gross margin return on investment and retailer capacity, the inventory management system 120 can determine an optimal stocking level. Using the above example, the inventory management system 120 can output an optimal stocking level of 4 units for Product 2 and 4 units for Product 3.

While certain embodiments of the disclosed technology have been described in connection with what is presently considered to be the most practical embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An inventory management method comprising:
receiving, at a computing device associated with a user, historical retail data relating to a first product;
receiving, at the computing device associated with the user, market demand data relating to the first product;
analyzing, by the computing device and using a stocking algorithm, the historical retail data and the market demand data relating to the first product to determine:
a projected number of sales of the first product for a specified time period; and
margin for each sale of the first product;
determining, by the computing device and based on (i) the projected number of sales of the first product for the specified time period and (ii) the margin for each sale of the first product; a gross margin return on investment for the first product;
determining, by the computing device and based on the gross margin return on investment for the first product, an optimal stocking level for the first product; and
outputting, for display at the computing device associated with the user, the optimal stocking level of the first product.

2. The method of claim 1, wherein the market demand data is obtained by:
receiving, at the computing device, customer registration data, manufacturer data, and sales data relating to the first product;
analyzing, by a market demand algorithm, an estimated market demand for the first product.

3. The method of claim 2, wherein the analyzing by the market demand algorithm comprises a regression-based optimization.

4. The method of claim 1, wherein the historical retail data comprises a historical sales pattern, historical price data, and historical location data relating to the first product.

5. The method of claim 1, wherein the determining the optimal stocking level comprises determining that the gross margin return on investment for the first product is below a predetermined threshold, and the outputting comprises a recommendation to remove the first product from stock.

6. The method of claim 1, the determining the optimal stocking level comprises determining that the gross margin return on investment for the first product is above a predetermined threshold that the first product is not in stock, and the outputting comprises an optimal stocking level of the first product.

7. The method of claim 1, wherein the optimal stocking level of the first product comprises a minimum stock level and a maximum stock level.

8. An inventory optimization method comprising:
receiving, at a computing device associated with a user, dealer inventory data comprising sales margin data and reward program data relating to a plurality of products;
receiving, at the computing device associated with the user, from a manufacturer associated with each of the plurality of products, product reward data and program prerequisite data;
analyzing, by a profit algorithm, the sales margin data and the reward program data relating to the plurality of products to determine constraints comprising:
a brand from the dealer inventory data;
a style from the plurality of products;
analyzing, by the profit algorithm, the product reward data and program prerequisite data to determine constraints comprising:
a manufacturer reward program;
program requirements;
optimizing, based on the profit algorithm, a total profit for the plurality of products; and
outputting, for display at the computing device associated with the user, a recommended quantity for each product from the plurality of products and one or more recommended reward programs associated with each product from the plurality of products.

9. The method of claim 8, wherein the product reward data comprises one or more of: an eligibility of the plurality of products, a required volume of the plurality of products, and a sales volume for each of the plurality of products.

10. The method of claim 8, wherein the optimizing based on the profit algorithm comprises a mixed-integer optimization.

11. The method of claim 8, wherein the product reward data comprises an object notation file comprising one or more parameters of a reward program associated with each of the plurality of products.

12. The method of claim 11, further comprising outputting, to the user, a level of progress attributed to the reward program associated with each of the plurality of products.

13. The method of claim 8, further comprising receiving, by the user at the computing device, a set of custom user preferences related to the manufacturer associated with each of the plurality of products, the custom user preferences comprising a volume adjustment and an equivalent product for each of the plurality of products.

14. The method of claim 8, further comprising, responsive to receiving the product reward data, converting the product reward data to a machine-readable medium.

15. The method of claim 14, wherein the machine-readable medium comprises a JavaScript object notation (JSON) file.

16. A stock management method comprising:
receiving, at a computing device associated with a user, historical retail data relating to a first product and a second product;
receiving, at the computing device associated with the user, market demand data relating to the third product;
analyzing, by a stocking algorithm, the historical retail data and the market demand data relating to the first product, the second product, and the third product;
optimizing, based on the stocking algorithm, a gross margin return on investment for each of the first product, the second product, and the third product;
determining that the gross margin return on investment for the first product and the second product is above a predetermined threshold;
determining that the gross margin return on investment for the third product is below the predetermined threshold;
outputting, to the user, an optimal stocking level of each of the first product and the second product; and
outputting, to the user, a recommendation to remove the third product from stock.

17. The method of claim 16, wherein the market demand data is obtained by:
receiving, at the computing device, customer registration data, manufacturer data, and sales data relating to the first product;
analyzing, by a market demand algorithm, an estimated market demand for the first product.

18. The method of claim 17, wherein the analyzing by the market demand algorithm comprises a regression-based optimization.

19. The method of claim 16, wherein the historical retail data comprises a historical sales pattern, historical price data, and historical location data relating to the first product.

20. The method of claim 16, further comprising outputting, to the user, a fourth product to replace the third product.
